(19) United States
(12) Patent Application Publication
(10) Pub. No.: US 2026/0259550 A1
(43) Pub. Date: Sep. 3, 2026

(54) CONTROL DEVICE AND COMPUTER-READABLE RECORDING MEDIUM

(71) Applicant: Fanuc Corporation, Minamitsuru-gun, Yamanashi (JP)

(72) Inventors: Naoya KOIDE, Minamitsuru-gun, Yamanashi (JP); Hiroyuki KAWAMURA, Minamitsuru-gun, Yamanashi (JP)

(73) Assignee: Fanuc Corporation, Minamitsuru-gun, Yamanashi (JP)

(21) Appl. No.: 18/881,907

(22) PCT Filed: Aug. 23, 2022
(86) PCT No.: PCT/JP2022/031733

§ 371 Date: Jan. 7, 2025

(51) Int. Cl. G05B 19/416

(52) U.S. Cl. CPC G05B 19/416; G05B 2219/49164

(57) ABSTRACT

A control device according to the present disclosure includes: an analysis unit that analyzes instructions by a control program; a corner detection unit that detects, on the basis of the analysis result by the analysis unit, a corner portion at which the direction of a moving route becomes discontinuous; a corner curving processing unit that executes curving by inserting a curve into the corner portion so as to adjust the velocity on the curved moving route; and a respective-direction velocity analysis unit that analyzes change in the velocity along the directional component of the moving route before and after the corner portion when moving on the inserted curve. When fluctuation of change in the velocity in the movement on the curve has been detected as a result of the analysis by the respective-direction velocity analysis unit, the control device instructs the corner curving processing unit to change corner curve processing so as to eliminate the fluctuation of change in the velocity on the curve.

### CROSS REFERENCE TO RELATED APPLICATIONS

This is the U.S. National Phase application of PCT/JP2022/031733, filed Aug. 23, 2022, the disclosure of this application being incorporated herein by reference in its entirety for all purposes.

### FIELD OF THE INVENTION

The present invention relates to a control device and a computer-readable recording medium.

### BACKGROUND OF THE INVENTION

In an industrial machine, such as a machine tool which has a plurality of feed axes, when the tool is moved along a path where a machining point is discontinuous, such as a right-angle corner, a feedrate is reduced at a corner part or the shape of the corner part is rounded to prevent the occurrence of shocks during passing through the corner (e.g. Patent Literature 1).

### PATENT LITERATURE

[Patent Literature 1] Japanese Patent Laid-Open Publication No. H9-190211

### SUMMARY OF THE INVENTION

For rounding the shape of the corner part, a method for inputting a circular arc, spline curve or clothoid curve may be applied. In such a case, however, if speed control is not devised, a speed waveform of each feed axis will have a wavy shape. It may cause shocks due to a change in acceleration or may lead to a decrease in machining accuracy.

Thus, it is important not only to round the shape of the corner part but also how to reduce the feedrate.

When a tool is moved along a path having its corner part curved, a control device according to the present disclosure estimates the speed of the tool in each direction before curving the corner part, and determines a speed at which the tool passes the corner part such that the rate of speed change in each direction monotonically varies. This can satisfy both of the smooth speed change arising from the curving and the reduction in the shocks on each axis, thereby solving the above-described problem.

One aspect of the present disclosure is a control device for driving each feed axis of an industrial machine based on a control program, including: an analyzer for analyzing a command in the control program; a corner detector for detecting a corner part at which the direction of a move path is discontinuous based on a result of an analysis conducted by the analyzer; a corner curve processing unit for inserting a curve into the corner part to round the corner part, so as to adjust a speed along a curved move path; and an each-direction speed analyzer for analyzing a speed change in a directional component in each of move paths in front of and behind the corner part when moving on the inserted curve, wherein when a result of an analysis shows that fluctuations in a speed change when moving on the curve are detected, the each-direction speed analyzer issues a command to the corner curve processing unit to change corner curve processing for eliminating the fluctuations in the speed change on the curve.

Another aspect of the present disclosure is a computer-readable recording medium that records a program for operating a computer as a control device for driving each feed axis of an industrial machine based on a control program, wherein the computer is operated as: an analyzer for analyzing a command in the control program; a corner detector for detecting a corner part at which a direction of a move path is discontinuous based on a result of analysis conducted by the analyzer; a corner curve processing unit for inserting a curve into the corner part to round it, so as to adjust a speed along the curved move path; and an each-direction speed analyzer for analyzing a speed change in a directional component in each of move paths in front of and behind the corner part when moving on the inserted curve, and wherein when a result of an analysis shows that fluctuations in a speed change when moving on the curve are detected, the each-direction speed analyzer issues a command to the corner curve processing unit to change corner curve processing for eliminating the fluctuations in the speed change on the curve.

According to one aspect of the present disclosure, when each of moving objects is moved along the path having curved corner part, a speed at which the moving object passes the corner part can be determined such that the rate of the speed change in each direction varies monotonically, so that the behavior of the moving object in each direction is stable and shocks on a machine can be reduced. Furthermore, there is an expectation for improvement in accuracy of machining the corner part.

### BRIEF DESCRIPTION OF THE DRAWINGS

FIG. 1 is a schematic hardware configuration diagram of a control device according to an embodiment of the present invention;

FIG. 2 is a block diagram schematically showing functions of the control device according to the embodiment of the present invention;

FIG. 3 shows an example of a corner part in a move path;

FIG. 4 shows an example of the move path to which a curve is inserted;

FIG. 5 shows an example of a change in acceleration of each of directional components when moving on the curve; and

FIG. 6 shows an example of changes in a speed and acceleration of a predetermined directional component when moving on the curve.

A description will now be made about an embodiment of the present invention by referring to the accompanying drawings.

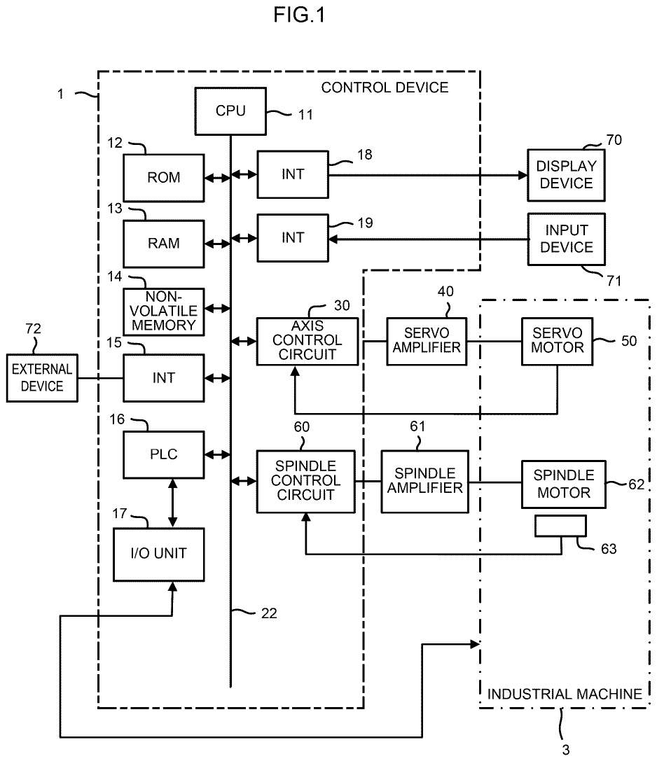

FIG. 1 is a schematic hardware configuration diagram showing main components of a control device according to an embodiment of the present invention. A control device 1 of the invention can be implemented as a control device for controlling industrial machines, such as machine tools and robots, which have a moving object moved by driving a motor. The following description provides an example of the control device 1 for controlling a relative position between a tool and a workpiece so as to control a machine tool for machining the workpiece.

The control device 1 of the present invention includes a central processing unit (CPU) 11 which is a processor for controlling the entire control device 1. The CPU 11 reads a system program stored in a read-only memory (ROM) 12 via a bus 22 to control the entire control device 1 according to the system program. A random-access memory (RAM) 13 is configured to temporarily store temporary computation data and pieces of data to be displayed, as well as various pieces of data input from outside.

A non-volatile memory 14 is configured with, for example, a memory or solid state drive (SSD), which is backed up by a battery not shown in the Figure, so that storage conditions can be retained even when a power source of the control device 1 is turned off. The non-volatile memory 14 is configured to store, for example, control programs and pieces of data read from an external device 72 via an interface 15, pieces of data and control programs input through an input device 71, and various data acquired from an industrial machine 3. The control programs and the various data stored in the non-volatile memory 14 may be deployed into the RAM 13 when they are executed/used. Furthermore, the ROM 12 stores various system programs, such as known analysis programs, in advance.

The interface 15 is configured to connect the CPU 11 in the control device 1 to the external device 72, such as a USB. From the external device 72, control programs, parameters and others used for controlling the industrial machine 3 can be read out. In addition to that, control programs, parameters and others edited in the control device 1 can be stored via the external device 72 in external storage means. A programmable logic controller (PLC) 16 is configured to send signals via an I/O unit 17 according to sequence programs stored in the control device 1 to the industrial machine 3 and peripheral devices of the industrial machine 3 (e.g., a turret, an actuator for a robot, sensors mounted on the industrial machine 3), so as to control the industrial machine 3 and the peripheral devices. Furthermore, the PLC 16 receives signals from various switches of an operator's panel disposed on the main body of the industrial machine 3 and signals from the peripheral devices, conducts necessary signal processing, and then transmits the signals to the CPU 11.

A display unit 70 is configured to display various data read into a memory, pieces of data acquired by executing the control programs, the system programs and the like, which are output through an interface 18. The input unit 71 is configured with a keyboard, a pointing device or the like and is configured to transfer commands, data and others according to operations made by an operator to the CPU 11 via an interface 19.

An axis control circuit 30 for controlling axes included in the industrial machine 3 is configured to receive an amount of movement command of an axis from the CPU 11 and then output the command of the axis to a servo amplifier 40. The servo amplifier 40 drives, upon receipt of this command, a servo motor 50 which is configured to move each of moving objects included in the industrial machine 3 along the axis. The servo motor 50 for the axis is built in a position/speed detector to feed a position/speed feedback signal from the position/speed detector back to the axis control circuit 30. The axis control circuit 30 conducts feedback control on the position and the speed of the servo motor 50. Although the hardware configuration diagram in FIG. 1 shows only one axis control circuit 30, one servo amplifier 40 and one servo motor 50, they are actually provided to the number of axes included in the industrial machine 3 to be controlled. For example, when a typical machine tool having linear three axes is controlled, three pairs of the axis control circuit 30, the servo amplifier 40 and the serve motor 50 are provided to move a spindle attached to a tool and a workpiece relatively in the directions of the linear three axes (X-axis, Y-axis, Z-axis).

A spindle control circuit 60 is configured to receive a spindle rotation command and send a spindle speed signal to a spindle amplifier 61. The spindle amplifier 61 is configured to, upon receipt of the spindle speed signal, rotate a spindle motor 62 in the industrial machine 3 at an instructed rotation speed to drive the spindle. To the spindle motor 62, a position coder 63 is coupled. The position coder 63 is synchronized with the rotation of the spindle to thereby output a feedback pulse, and the feedback pulse is read by the CPU 11.

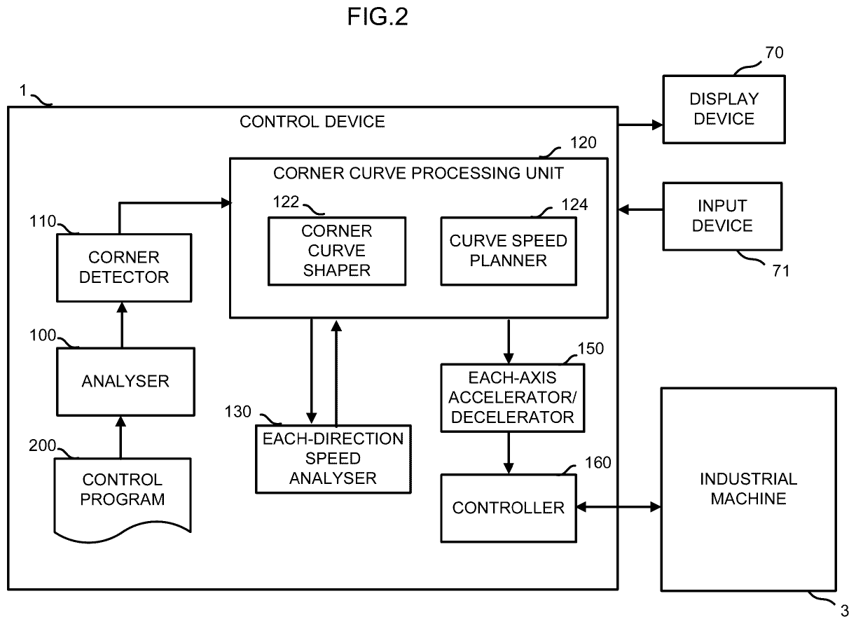

FIG. 2 is a block diagram that schematically shows functions of the control device 1 according to an embodiment of the present invention. The control device 1 according to the embodiment controls a relative position between a rotating tool and a workpiece so as to bring the tool into contact with the workpiece for cutting the workpiece. The various functions of the control device 1 according to the embodiment are implemented in such a way that the CPU 11 included in the control device 1 shown in FIG. 1 executes the system programs to control the operations of the components of the control device 1.

The control device 1 of the embodiment includes an analyzer 100, a corner detector 110, a corner curve processing unit 120, a corner curve shaper 122, a curve speed planner 124, an each-direction speed analyzer 130, an each-axis accelerator/decelerator 150, and a controller 160. Furthermore, a control program 200 to be used for controlling the industrial machine 3 is stored beforehand in the RAM 13 and the non-volatile memory 14 in the control device 1.

The analyzer 100 is configured to successively read blocks of a control program 200. The analyzer 100 in turn analyzes commands issued by the blocks thus read out. The control program 200 includes commands about a stroke, a move path and a move speed of a feed axis, for instance. The analyzer 100 analyzes these commands to generate data on a movement command for controlling the position of each servo motor 50. In a case where the control program 200 includes a rotation speed command for the spindle, data about a spindle rotation command for controlling the rotation of the spindle motor 62 is generated. It is desirable that the analyzer 100 conducts the analysis by looking ahead the blocks. The analyzer 100 outputs the generated data on the commands to the corner detector 110.

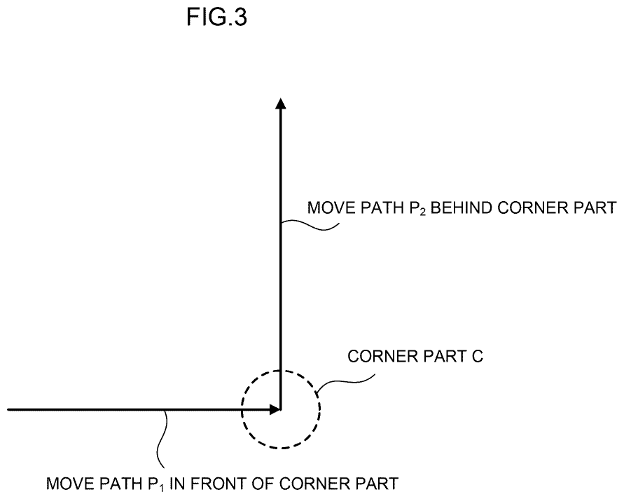

The corner detector 110 is configured to detect a corner part at which the direction of the move path is discontinuous, based on the data about the movement command input from the analyzer 100. In this description, the corner part means a part between two consecutive move paths P₁ and P₂ at which the direction of the move path P₁ in front of this part is discontinuously connected to the direction of the move path P₂ behind this part. FIG. 3 shows an example of the corner part. The example in FIG. 3 shows that the direction of the move path P₁ in front of the corner part is connected at an approximate right angle to the direction of the move path P₂ behind the corner part. In addition to the angle illustrated in FIG. 3, the corner part C may be connected at more acute angle or more obtuse angle. Furthermore, the move paths P₁ and P₂ in front of and behind the corner part are not necessarily straight, and may be in a curve. The corner detector 110 detects a connection point between the move paths based on the data on the movement command input from the analyzer 100. Then, when an angle formed by the move paths in front of and behind the connection point is equal to or smaller than a predefined given angle θₜₕ (θₜₕ<180°), this connection point is detected as a corner part, by way of example.

The corner curve processing unit 120 is configured to curve the corner part detected by the corner detector 110, and adjust the speed on the curved move path. The corner curve processing unit 120 includes a corner curve shaper 122 and a curve speed planner 124.

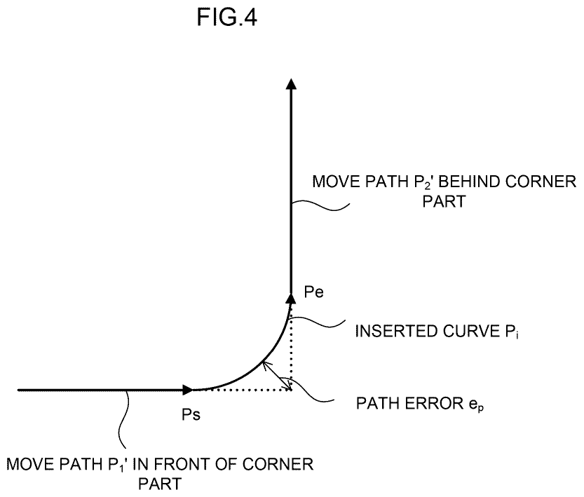

The corner curve shaper 122 is configured to insert a curve into the corner part detected by the corner detector 110 to change the corner part into a new move path. FIG. 4 shows an example of a curve to be inserted into the corner part by the corner curve shaper 122. The corner curve shaper 122 inserts a curve Pᵢ into the corner part C, the curve Pᵢ having a predetermined point Ps as a start point on the move path in front of the corner part and a predetermined point Pe as an end point on the move path behind the corner part. The curve inserted at this time has the shortest distance from the connection point between the move paths P₁ and P₂, the shortest distance being equal to or shorter than a predefined given acceptable path error ep. Then, the corner curve shaper 122 replaces the move path P₁ in front of the corner part with a move path P_{1′} with its end point being the point Ps while replacing the move path P₂ behind the corner part with a move path P_{2′} with its start point being the point Pe, thereby creating a new move path. The inserted curve only needs to be such that the position, the speed, and the acceleration on both ends are almost continuous with the move paths P_{1′}, P_{2′}, respectively in front of and behind the corner part. In addition, it is preferable that the inserted curve can be differentiated twice or more. Such a curve insertion is known in, for instance, Japanese Patent Laid-Open Publication Nos. H9-190211 and H10-320026, and it is therefore not described in detail herein.

The curve speed planner 124 is configured to create a speed plan for moving on the curve inserted by the corner curve shaper 122. In a case of creating a speed plan for moving on the curve for the first time, the curve speed planner 124 creates the speed plan according to the setting of acceleration and deceleration defined in the control device 1. The curve speed planner 124 outputs the created speed plan to the each-direction speed analyzer 130.

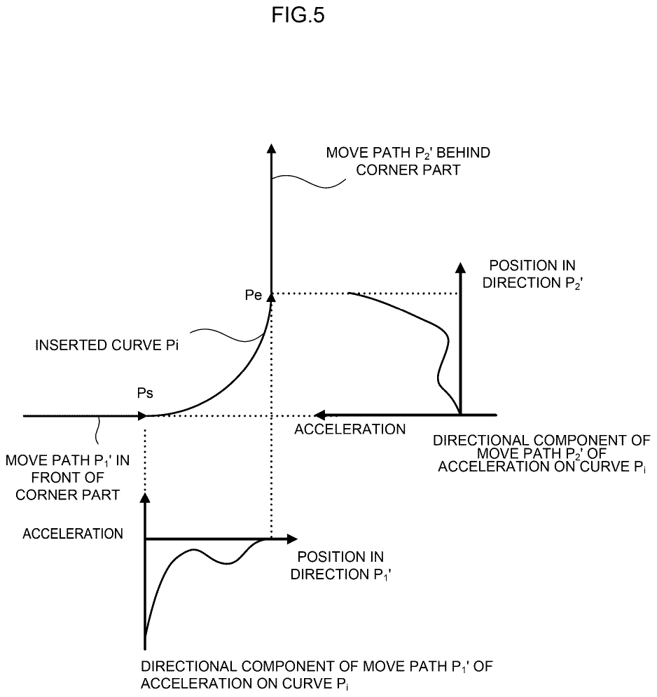

The each-direction speed analyzer 130 is configured to analyze the speed plan for moving on the curve created by the curve speed planner 124 with respect to the move path created by the corner curve shaper 122. In this analysis, the each-direction speed analyzer 130 disassembles the speed plan for moving on the curve into direction components of the move paths in front of and behind the corner part, thereby analyzing the speed change in each direction component. FIG. 5 illustrates the speed change in the direction components of the move paths in front of and behind the corner part while moving on the curve. As shown in FIG. 5, the speed in the direction of the move path P_{1′} decelerates along the curve on the whole (the acceleration asymptotically increases from negative to zero), whereas the speed in the direction of the move path P_{2′} accelerates along the curve on the whole (the acceleration gradually increases from zero). However, as the object approaches the midpoint of the curve, the speed in the direction of the move path P_{1′}, which was once weakened, is temporarily decelerated (acceleration in the negative direction), and the speed in the direction of the move path P_{1′} is temporarily accelerated (acceleration in the positive direction). Such a temporary change in the acceleration occurs under the influence of the acceleration caused due to the shape of the curve (change in curvature). As above, fluctuations occur in the speed change on the curve that appear as shocks during moving on the curve. The each-direction speed analyzer 130 detects the fluctuations in the speed change on the curve (temporary fluctuations in the acceleration) as a change in a sign of the rate of change in the acceleration (presence of extreme values in the acceleration).

When the result of the analysis shows that no fluctuations in the speed change on the curve are detected, the each-direction speed analyzer 130 issues a command to the corner curve processing unit 120 to operate the axes based on the created speed plan. On the other hand, when the result of the analysis shows that the fluctuations in the speed change on the curve are detected, the each-direction speed analyzer 130 issues a command to the corner curve processing unit 120 to change the corner curve processing for eliminating the fluctuations in the speed change on the curve.

There is an example of changing the corner curve processing to eliminate the fluctuations in the speed change on the curve in which an acceptable path error ep at the corner part is changed. The principal purpose of this method is to reduce the acceptable path error ep to thereby bringing the positions, where the local maximum point and the local minimum point of the acceleration appear, close together. This can prevent the change in the sign of the rate of change of the acceleration, and also prevents the occurrence of the fluctuations in the speed change.

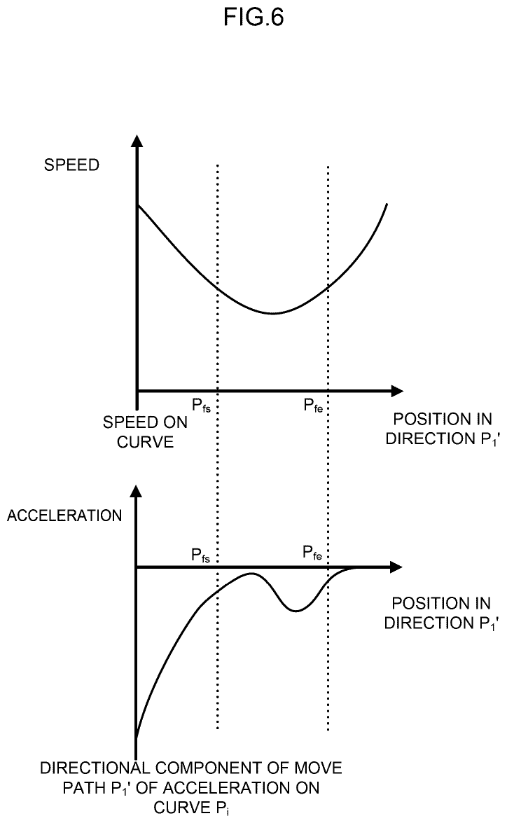

There is another example of changing the corner curve processing to eliminate the fluctuations in the speed change on the curve in which the speed is varied before and after the occurrence of the fluctuations in the speed change. The purpose of this method is to increase the speed before and after the occurrence of the fluctuations in the speed change to thereby eliminate the local maximum point and the local minimum point of the acceleration. FIG. 6 is a graph showing examples of the speed on the curve and the acceleration of one directional component. When the fluctuations in the speed change occur during moving on the curve, the local maximum point and the local minimum point appear in the change in the acceleration, as illustrated in FIG. 6. Provided that ranges in which the fluctuations in the speed change occur are defined as P_{fs} to P_{fe}, the speed is increased in these ranges to increase the acceleration of each directional component in those ranges, thereby eliminating the local maximum and minimum points. This can prevent the occurrence of the fluctuations in the speed change.

There is yet another example of changing the corner curve processing to eliminate the fluctuations in the speed change on the curve in which the acceleration of a predetermined directional component is changed before and after the occurrence of the fluctuations in the speed change. The purpose of this method is to decrease an absolute value of the acceleration of the predetermined directional component before and after the occurrence of the fluctuations in the speed change, for instance, so as to eliminate the local maximum and minimum points of the acceleration. That is to say, by decreasing the absolute value of the acceleration in the ranges P_{fs} to P_{fe} shown in FIG. 6 in which the fluctuations in the speed change occur (bring the absolute value close to zero), the local maximum and minimum points can be eliminated. This can prevent the occurrence of the fluctuations of the speed change.

When the fluctuations in the speed change on the curve is detected, the each-direction analyzer 130 issues a command to the corner curve processing unit 120 to conduct at least any one of the above-described corner curve processing methods. When the command is for changing the acceptable path error ep, the corner curve processing unit 120 issues a command, in response to the change command, to the corner curve shaper 122 to insert a curve that satisfies the changed acceptable path error ep. Furthermore, when the command is for changing the speed or the acceleration, the corner curve processing unit 120 issues a command to the curve speed planner 124 to create a speed plan in which the speed or acceleration in a designated range is varied. The each-direction speed analyzer 130 then analyzes the newly created speed plan. The above-described procedure is repeated until no fluctuations in the speed change are detected. Finally, when a move path and a speed plan that do not cause the occurrence of the fluctuations in the speed change are created, the created move path and speed plan are output along with the data about a move command to the each-axis accelerator/decelerator 150.

The each-axis accelerator/decelerator 150 computes a stroke for each control cycle of each axis of the industrial machine 3 based on the move path and the speed plan that do not cause the occurrence of the fluctuations in the change created by the corner curve processing unit 120, so as to conduct acceleration/deceleration processing on the computed stroke.

Then, the controller 160 controls the motor for each component of the industrial machine 3 on the basis of the stroke subjected to the acceleration/deceleration processing by the each-axis accelerator/decelerator 150 and the data about the spindle rotation command.

Since the control device 1 with the above-described configuration can determine the speed to pass the corner part so that the rate of change of the speed in each direction monotonically varies when the moving object is moved along the path having the curved corner part, the behavior in each direction is stabilized and the shocks to the machine are reduced. In addition to that, the improvement in accuracy of machining the corner part is expected.

The present invention has been described with reference to the above-described embodiment, but is not limited to the embodiment. Thus, the present invention can be implemented in various aspects by modifying the invention appropriately.

### REFERENCE NUMERALS LIST

1 Control Device
3 Industrial Machine
11 CPU
12 ROM
13 RAM
14 Non-Volatile Memory
15, 18, 19 Interface
16 PLC
17 I/O Unit
22 Bus
30 Axis Control Circuit
40 Servo Amplifier
50 Servo Motor
60 Spindle Control Circuit
61 Spindle Amplifier
62 Spindle Motor
63 Position Coder
70 Display Device
71 Input Device
72 External Device
100 Analyzer
110 Corner detector
120 Corner Curve Processing Unit
122 Corner curve shaper
124 Curve Speed Planner
130 Each-direction Speed Analyzer
150 Each-axis Accelerator/Decelerator
160 Controller
200 Control Program

1. A control device for driving a feed axis of an industrial machine based on a control program, comprising:
an analyzer for analyzing a command in the control program;
a corner detector for detecting a corner part at which a direction of a move path is discontinuous, based on a result of an analysis conducted by the analyzer;
a corner curve processing unit for inserting a curve into the corner part to round the corner part, so as to adjust a speed along a curved move path; and
an each-direction speed analyzer for analyzing a speed change in a directional component of each of move paths in front of and behind the corner part when moving on the inserted curve,
wherein when a result of an analysis shows that fluctuations in a speed change when moving on the curve are detected, the each-direction speed analyzer issues a command to the corner curve processing unit to change corner curve processing for eliminating the fluctuations in the speed change on the curve.

2. The control device according to claim 1, wherein the corner curve processing unit comprises a corner curve shaper for creating a new move path in which the curve is inserted into the corner part, and
wherein the each-direction speed analyzer issues a command to the corner curve processing unit to change an acceptable path error of the curve to be smaller when the result of the analysis shows that the fluctuations in the speed change when moving on the curve are detected, and
the corner curve shaper re-creates a curve in which an acceptable path error is changed to be smaller based on the command.

3. The control device according to claim 1, wherein the corner curve processing unit comprises a curve speed planner for creating a speed plan for determining shifts of the speed and acceleration when moving on the curve, and
wherein when the result of the analysis shows that the fluctuations in the speed change when moving on the curve are detected, the each-direction speed analyzer issues a command to the corner curve processing unit to change the speed to be higher in a range in which the fluctuations in the speed change occur when moving on the curve, and
the curve speed planner re-creates a speed plan based on the command to change the speed to be higher in the range in which the fluctuations in the speed change occur.

4. The control device according to claim 1, wherein the corner curve processing unit comprises a curve speed planner for creating a speed plan for determining shifts of the speed and acceleration when moving on the curve, and
wherein when the result of the analysis shows that the fluctuations in the speed change when moving on the curve are detected, the each-direction speed analyzer issues a command to the corner curve processing unit to change an absolute value of accelerator to be smaller in a range in which the fluctuations in the speed change occur when moving on the curve, and
the curve speed planner re-creates a speed plan based on the command to change the absolute value of the acceleration to be smaller in the range in which the fluctuations in the speed change occur.

5. A computer-readable recording medium that records a program for operating a computer as a control device for driving a feed axis of an industrial machine based on a control program, wherein
the computer is operated as:
an analyzer for analyzing a command in the control program;
a corner detector for detecting a corner part at which a direction of a move path is discontinuous based on a result of analysis conducted by the analyzer;
a corner curve processing unit for inserting a curve into the corner part to round it, so as to adjust a speed along the curved move path; and
an each-direction speed analyzer for analyzing changes in a speed of a directional component in each of move paths in front of and behind the corner part while moving on the inserted curve, and
wherein when a result of an analysis shows that fluctuations in a speed change while moving along the curve are detected, the each-direction speed analyzer issues a command to the corner curve processing unit to change corner curve processing for eliminating the fluctuations in the speed change on the curve.
